(19) United States
(12) Patent Application Publication
(10) Pub. No.: US 2020/0292340 A1
(43) Pub. Date: Sep. 17, 2020

(54) ROBOT RUNNING PATH, GENERATION METHOD, COMPUTING DEVICE AND STORAGE MEDIUM

(71) Applicant: TENCENT TECHNOLOGY (SHENZHEN) COMPANY LIMITED, Shenzhen (CN)

(72) Inventor: Da Shuang LI, Shenzhen (CN)

(73) Assignee: TENCENT TECHNOLOGY (SHENZHEN) COMPANY LIMITED, Shenzhen (CN)

(21) Appl. No.: 16/887,382

(22) Filed: May 29, 2020

Related U.S. Application Data
(63) Continuation of application No. PCT/CN2019/073897, filed on Jan. 30, 2019.

(30) Foreign Application Priority Data
Feb. 6, 2018 (CN) 201810116720.2

(51) Int. Cl. G01C 21/34

(52) U.S. Cl. CPC G01C 21/3469; G01C 21/3446

(57) ABSTRACT

A computing device, a storage medium and a method for generating a robot running path. The method for generating the robot running path may include receiving a path generation request, randomly generating a plurality of alternative paths according to the start path point, the end path point, and preset path points, determining a cost value of each alternative path in the plurality of alternative paths according to at least one target value of each alternative path, determining a plurality of alternative path groups according to the cost value and the at least one target value of each alternative path, and determining a target running path of a robot based on the plurality of alternative path groups and the cost value of each alternative path.

### CROSS-REFERENCE TO RELATED APPLICATION(S)

This application is a continuation of PCT/CN2019/073897 and claims priority to Chinese Patent Application No. 201810116720.2, entitled “ROBOT RUNNING PATH GENERATION METHOD, COMPUTING DEVICE AND STORAGE MEDIUM” and filed on Feb. 6, 2018, both of which are incorporated by reference herein in their entirety.

### BACKGROUND

### 1. Field

Embodiments of the disclosure relate to the field of computer technologies, and in particular, to a method for generating a robot running path, a computing device, and a storage medium thereof.

### 2. Description of Related Art

One of the problems associated with robot running path planning, deep learning, and test case generation is that there may be a plurality of solution sets, including an optimal solution that satisfies the objective of the above operations. In other words, because there are many solution sets to achieve one objective, it is often difficult to reach the optimal solution due to complexity and limitation on time. For example, a solution set of robot path planning may be a plurality of paths, including the shortest path therein, or a path (for example, a path for which a path distance, time consumption and energy consumption are most appropriate) that satisfies a plurality of objectives.

However, a situation in an actual environment is relatively complex. The foregoing problem is a non-deterministic polynomial-time hardness (NP-hard) problem. That is, there may be excessive solution sets, and the optimal solution may not be found in a limited time. In certain situations, only a search solution space may be expanded to constantly find a better solution. Generally, a fast elitism non-dominated sorting genetic algorithm-II (NSGA-II) is used to solve the NP-hard problem.

However, when the NSGA-II is used for solving the NP-hard problem, the adaptability of an obtained solution set is relatively low. For example, when a robot running path is generated, the obtained path may not be a path that best satisfies a requirement, and may increase the running costs of a robot.

### SUMMARY

Embodiments of the disclosure provide a method for generating a robot running path, a computing device, and a storage medium, to solve the above problems. However, the problems identified above are not limited thereto, and embodiments of the disclosure may solve other problems that are not identified herein.

According to an embodiment, there is provided a method for generating a robot running path, performed by a computing device, the method including receiving a path generation request, the path generation request including a start path point and an end path point; randomly generating a plurality of alternative paths according to the start path point, the end path point, and preset path points; determining a cost value of each alternative path in the plurality of alternative paths according to at least one target value of each alternative path, the at least one target value comprising at least one of a path length, a time duration, or an amount of energy consumption of the alternative path; determining a plurality of alternative path groups according to the cost value and the at least one target value of each alternative path; and determining a target running path of a robot based on the plurality of alternative path groups and the cost value of each alternative path.

According to an embodiment, there is provided a computing device including at least one memory configured to store computer program code and at least one processor configured to access the computer program code and operate as instructed by the computer program code. The computer program code including: receiving code configured to cause the at least one processor to receive a path generation request, the path generation request including a start path point and an end path point; generation code configured to cause the at least one processor to randomly generate a plurality of alternative paths according to the start path point, the end path point, and preset path points; first determining code configured to cause the at least one processor to determine a cost value of each alternative path in the plurality of alternative paths according to at least one target value of each alternative path, the at least one target value comprising at least one of a path length, a time duration, and an amount of energy consumption of the alternative path; second determining code configured to cause the at least one processor to determine a plurality of alternative path groups according to the cost value and the at least one target value of each alternative path; and third determining code configured to cause the at least one processor to determine a target running path of a robot based on the plurality of alternative path groups and the cost value of each alternative path.

According to an embodiment, there is provided a non-transitory computer-readable storage medium, storing one or more programs including at least one instruction, when the at least one instruction is loaded and executed by a processor, cause the processor to: receive a path generation request, the path generation request including a start path point and an end path point; randomly generate a plurality of alternative paths according to the start path point, the end path point, and preset path points; determine a cost value of each alternative path in the plurality of alternative paths according to at least one target value of each alternative path, the at least one target value comprising at least one of a path length, a time duration, and an amount of energy consumption of the alternative path; determine a plurality of alternative path groups according to the cost value and the at least one target value of each alternative path; and determine a target running path of a robot based on the plurality of alternative path groups and the cost value of each alternative path.

### BRIEF DESCRIPTION OF THE DRAWINGS

To describe the technical solutions of the embodiments of the disclosure more clearly, the following description briefly introduces the accompanying drawings for describing the embodiments. Apparently, the accompanying drawings described below are only some of the embodiments of the disclosure, and a person of ordinary skill in the art may derive other embodiments from the accompanying drawings and the descriptions thereof without creative efforts.

FIG. 1 is a diagram of an implementation environment according to an embodiment.

FIG. 2 is a flowchart of a fast elitism non-dominated sorting method according to an embodiment.

FIG. 3 is a flowchart of a method for generating a robot running path according to an embodiment.

FIG. 4 is a flowchart of a multi-objective hybrid colonial competitive algorithm according to an embodiment.

FIG. 5 is a schematic diagram of a generation of a robot running path according to an embodiment.

FIG. 6 is a flowchart of a target combination algorithm according to an embodiment.

FIG. 7 is a flowchart of an alternative path optimization process according to an embodiment.

FIG. 8 is a schematic diagram of a partial cross-mapping according to an embodiment.

FIG. 9 is a schematic diagram of a late acceptance hill-climbing algorithm according to an embodiment.

FIG. 10 is a flowchart of a method for determining a problem solution according to an embodiment.

FIG. 11 is a flowchart of a target combination algorithm according to an embodiment.

FIG. 12 is a flowchart of an alternative solution optimization process according to an embodiment.

FIG. 13 is a schematic diagram of an apparatus for generating a robot running path according to an embodiment.

FIG. 14 is a schematic diagram of an apparatus for generating a robot running path according to an embodiment.

FIG. 15 is a schematic structural diagram of a computing device according to an embodiment.

### DESCRIPTION

To make the objectives, technical solutions, and advantages of certain embodiments of the disclosure clearer, the following description describes the embodiments of the disclosure in detail with reference to the accompanying drawings.

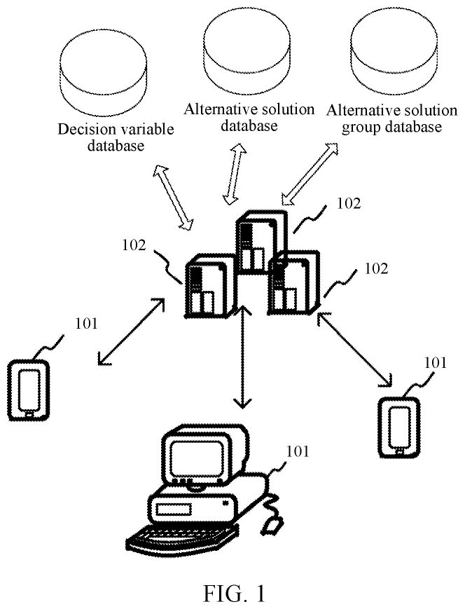

FIG. 1 is a diagram of an implementation environment according to an embodiment. The implementation environment includes a plurality of terminal devices 101, and a computing device 102 configured to provide a service to the plurality of terminals 101. The plurality of terminals 101 are connected to the computing device 102 through a wireless or wired network. The plurality of terminals 101 may access the computing device 102 through the network. The plurality of terminals 101 may be computers, smartphones, tablet computers, or other terminals. The computing device 102 may be one or more computing devices. The computing device 102 may perform a computing operation on a target problem to find a solution to the target problem based on a computing request. The computing request may be sent by a user of a terminal device 101 to the computing device 102. The computing device 102 may be a server having a computing capability, or may be a terminal capable of computing the foregoing target problem. The computing device 102 may further include at least one database configured to store decision variable data, alternative solution data, alternative solution group data, and the like. According to an embodiment, the terminal 101 may request the computing device 102 to analyze the problem to provide the solution. Alternatively, the terminal 101 may serve as a performer to analyze the problem by performing specific steps based on information received from the computing device 102.

According to an embodiment, the target problem may refer to a complex multi-objective NP-hard problem such as robot running path generation, deep learning, or test case generation. A corresponding algorithm model may generally be used to resolve such a problem to obtain a corresponding solution. When querying and calculating such a problem through the terminal 101, a user can solve the target problem through a corresponding algorithm model. For example, the computing device 102 is a path planning computing device, where the path planning computing device refers to a computing device capable of providing a path planning service, and a path planning process refers to a path generation process. In this case, a plurality of path points and node description information, an algorithm model corresponding to path optimization, and the like are stored in the computing device 102. When a user requests a path query from a start point to an end point of a path through the terminal 101, the terminal 101 may transmit the computing request to the computing device 102, and the computing device 102 computes a preferred path between the start point and the end point through the algorithm model.

The terms used in the disclosure are explained below.

NP-hard problem: NP refers to a non-deterministic polynomial. The non-deterministic means that a certain quantity of operations are not available to solve a problem that may be resolved in polynomial time. Common NP-hard problems may include robot path planning, deep learning, test case generation, and the like.

Pareto front: If at least one of target values of an individual i is better than a target value of an individual h, and the other target values of the individual i are not worse than the target value of the individual h, the individual i can dominate the individual h. If no other individuals that can dominate the individual i can be found, the individual i is referred to as a Pareto optimal solution. A set including a plurality of Pareto optimal solutions is defined as a Pareto optimal solution set. All individuals in the Pareto optimal solution set are non-dominated solutions. The non-dominated solution means that none of the other individuals can dominate the individual. Connection lines of the individuals are referred to as the Pareto front.

Multi-objective hybrid colonial competitive algorithm (MOHCCA): The MOHCCA is a new intelligent optimization algorithm inspired by imperial competition behavior and belongs to a group-based random optimization search algorithm. The colonial competitive algorithm is a metaheuristic algorithm generated through inspiration by a colonial competition process between countries in the old society in which countries with relatively strong economic and military power exercise colonial control over backward countries and powerful countries compete with each other. The algorithm is a novel algorithm that is based on numerous countries and global searches for an optimal solution based on a plurality of country groups, and has a relatively strong global capability. Countries having a strong capability can occupy resources of colonies or exploit colonial peoples, so that the countries are increasingly powerful.

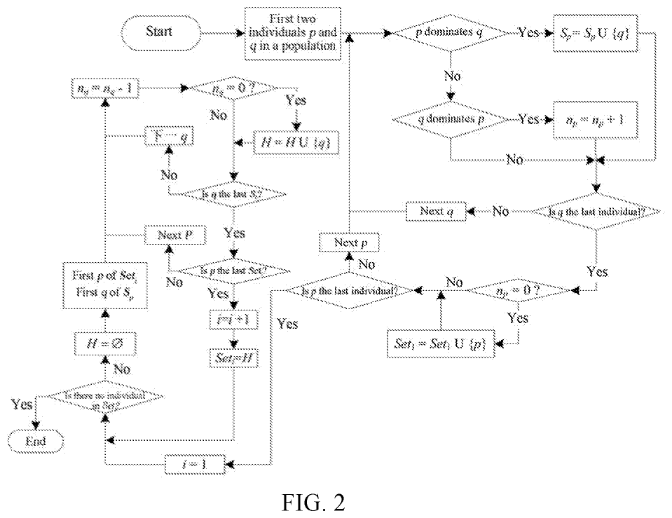

Fast elitism non-dominated sorting method: Referring to FIG. 2, the fast elitism non-dominated sorting method is mainly intended to put each individual into different levels of Pareto solution sets according to a degree of dominance between individuals. A first rank Pareto solution set can dominate all individuals (that is, individuals on a Pareto front curve) in other sets, and solution sets of other ranks can be dominated only by solution sets of previous ranks.

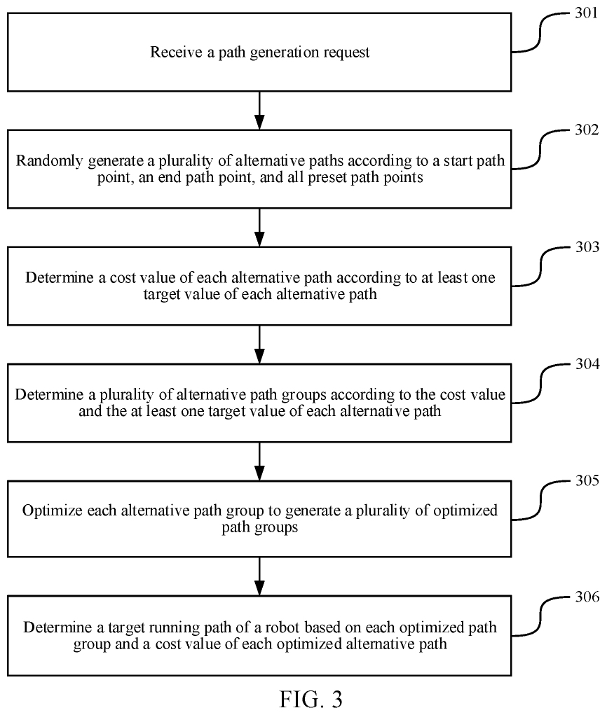

FIG. 3 is a flowchart of a method for generating a robot running path according to an embodiment and FIG. 4 is a flowchart of a multi-objective hybrid colonial competitive algorithm according to an embodiment. Referring to FIGS. 3 and 4, the method for generating a robot running path is applied to a computing device. The computing device may be a server, or may be a terminal. An example in which the computing device is a server is used for the following description.

Referring to FIG. 3, in step 301, the server receives a path generation request. The path generation request carries a start path point and an end path point. Each path point and node description information may be preset in the server and stored in a database. The node description information may be attribute information related to the path point. For example, the node description information may be the maximum traffic allowed by a node, a connection relationship between nodes (for example, passing from a node A to a node B is allowed, but passing from the node A to a node C is not allowed), or the like. The node may also refer to a path point.

A positioning component may be installed in a robot, and may obtain current position information of the robot. When the robot needs to run from a current position to a destination, the current position may be used as the start path point, and the destination may be used as the end path point. The start path point and the end path point are added to the path generation request, and then the path generation request is sent to the server. Further, the server may receive the path generation request that carries the start path point and the end path point.

In step 302, the server may randomly generate a plurality of alternative paths according to the start path point, the end path point, and all preset path points.

Before the alternative paths are randomly generated, a generation problem of a robot running path needs to be constructed. Specifically, decision variables, constraints, objective functions, and the like of the generation problem of the robot running path need to be set. The decision variables of the generation problem of the robot running path may be a path point, a path length, a time duration, an energy consumption, and the like. The path length, the time duration, the energy consumption, and the like may be obtained by calculating the path point and a preset running speed. The constraints may be set according to corresponding node description information. The objective functions may be a single objective function. For example, the objective functions have the shortest path, the shortest duration, the least amount of energy consumption, or the like. Alternatively, the objective functions may be a multiple objective function. For example, a combination of a path distance, the time duration, and the energy consumption that is most appropriate. That is, a target value of the alternative path may include one or more of the following: a path length of the alternative path, a time duration of the alternative path, and energy consumption of the alternative path.

During construction of the generation problem of the robot running path, the decision variables may be constructed according to the path point, and then the constraints of the generation problem of the path may be constructed according to the node description information. The server may randomly select an intermediate path point from all the preset path points according to an input start path point and an input end path point to obtain an alternative path. Then, the server may determine whether the alternative path satisfies the constraints. If the alternative path satisfies the constraints, it indicates that the alternative path is a feasible solution, and the alternative path may be reserved for subsequent processing. If the alternative path does not satisfy the constraints, it indicates that the alternative path is a non-feasible solution, and the alternative path may be discarded and another alternative path may be regenerated.

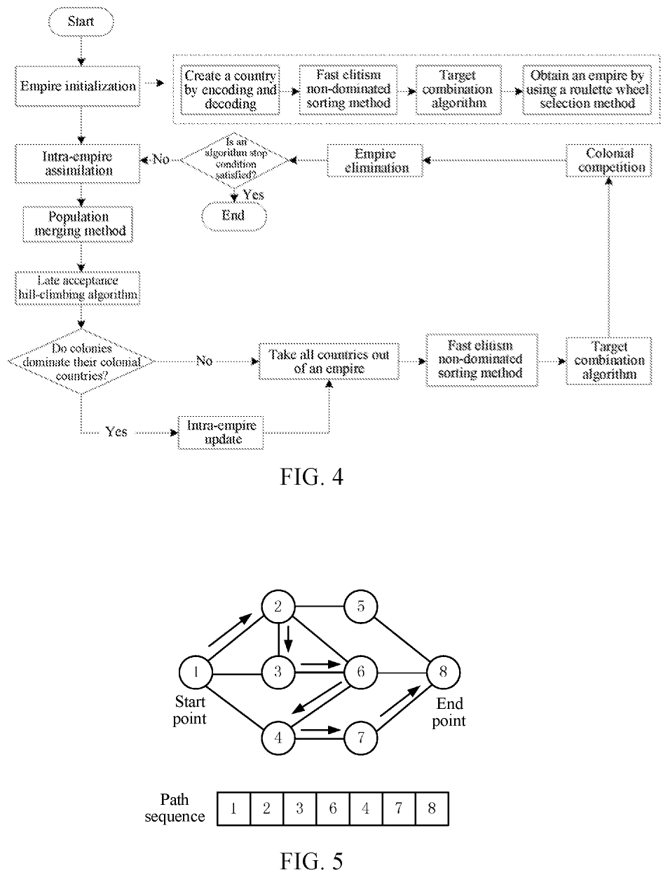

As shown in FIG. 5, which is a schematic diagram of a generation problem of a robot running path, path points (or nodes) may have corresponding numbers, and a number sequence may be generated according to the numbers of the path points to represent a path. The beginning of the sequence is a path start point, and the end of the sequence is a path end point. The foregoing process may be repeated to randomly generate a preset quantity of number sequences. That is, a preset quantity of paths are randomly generated. For example, the preset quantity may be 30, but the preset quantity is not limited thereto.

In step 303, the server may determine a cost value of each alternative path according to at least one target value of each alternative path.

After the plurality of alternative paths are randomly generated, to vividly describe a dominant relationship between different paths, each alternative path may be used as a country to obtain a plurality of countries. One or more target values of each country may be calculated according to the foregoing objective function, so as to determine a cost value of each country based on the one or more target values.

For a single objective problem, the target value can be directly used to represent a cost value of a country. However, for a multi-objective problem, a cost value of a country cannot be directly measured by using a certain target value, and a plurality of target values need to be combined and calculated to obtain the cost value. Cost values of the plurality of countries may be obtained through a same or similar operation on each country. Specifically, the process of determining, by the server, a cost value of each alternative path in step 303 may be as follows. The server may determine the cost value of each alternative path according to the at least one target value of each alternative path by invoking a target combination algorithm.

In addition, before the cost value of each country is calculated, the server may classify each country according to a fast non-dominated sorting algorithm to obtain a rank of each country to calculate a corresponding cost value. Here, the rank of each country and the corresponding cost value can be determined by classifying each alternative path according to the at least one target value of each alternative path to obtain a rank of each alternative path and determining the cost value of each alternative path according to the at least one target value of each alternative path and the rank of each alternative path.

Specifically, after the at least one target value of each country is obtained, the server may determine a degree of dominance between countries according to the fast non-dominated sorting algorithm, and put each country into different levels of Pareto solution sets. Each level may correspond to a rank, and each country may obtain a corresponding rank of the country. A level of a country having a highest degree of dominance may be at a first level, and a corresponding rank may be a first rank.

Further, the server may calculate the cost value of each country through a target combination algorithm according to the at least one target value of each country and the corresponding rank. For the multi-objective problem, status equality and optimization reciprocity exist between the target values. The target combination algorithm refers to the corresponding rank of each country, and can ensure that a cost value of a country having a better Pareto solution set is also better.

A generation problem of the robot running path including two objective functions may be used as an example. If the problem is that a smaller target value is preferred, a formula of the target combination algorithm may be expressed as follows:

$$\begin{matrix}{Cost}_{i} = {\sum }_{k = 1}^{2} [ {f}_{k} ( i ) \text{/} {\sum }_{j = 1}^{{N}_{rank}} {f}_{k} ( j ) ] + {( {rank}_{i} - 1 )}^{*} 2 & ( 1 ) \\ {NormCost}_{i} = max ( C o s {t}_{n} ) - {Cost}_{i} + 1 & ( ( 2 )\end{matrix}$$

Costᵢ is an initial cost value of an i^{th} country, fₖ(i) is a k^{th} target value of the i^{th} country, fₖ(j) is a k^{th} target value of a j^{th} country, Nᵣₐₙₖ a quantity of countries in each rank of Pareto solution set, and rankᵢ is a rank (that is, a level) corresponding to the i^{th} country. NormCostᵢ is a cost value of the i^{th} country, max(Costₙ) is a maximum value of initial cost values of all countries, and Σ is a summation function. The formula (2) shows that a country having a largest initial cost value has a minimum cost value, and the cost value is 1. For other countries, a country whose initial cost value has a larger difference with the initial cost value of the country having the largest initial cost value may have a larger corresponding cost value. Similarly, a country having a smaller initial cost value may have a larger cost value, which is consistent with the problem that a smaller target value is preferred.

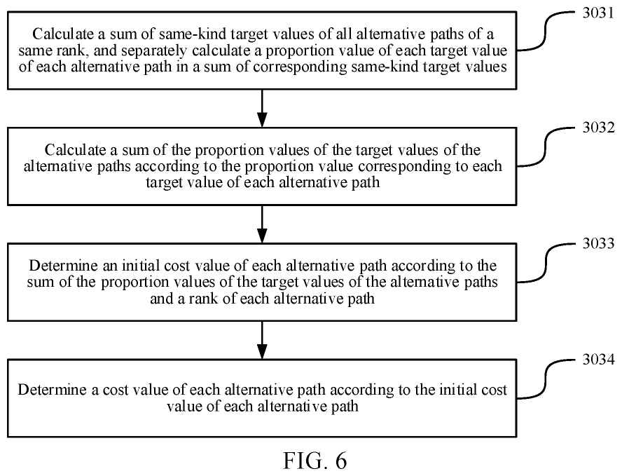

Referring to a flowchart of a target combination algorithm shown in FIG. 6, specifically, the process of calculating according to the target combination algorithm in step 302 may be shown in the following step 3021 to step 3024.

In step 3031, the server calculates a sum

$${\sum }_{{ }^{j = 1}}^{{N}_{rank}} {f}_{k} ( j )$$

of same-kind target values of all alternative paths of a same rank, and separately calculates a proportion value

$${f}_{k} ( i ) \text{/} {{\sum }_{j = 1}}^{{N}_{r a n k}} {f}_{k} ( j )$$

of each target value of each alternative path in a sum of corresponding same-kind target values.

In step 3032, the server calculates a sum

$${\sum }_{k = 1}^{2} [ {f}_{k} ( i ) \text{/} {{\sum }_{j = 1}}^{{N}_{r a n k}} {f}_{k} ( j ) ]$$

of the proportion values of the target values of the alternative paths according to the proportion value corresponding to each target value of each alternative path.

In step 3033, the server determines an initial cost value Costᵢ of each alternative path according to the sum of the proportion values of the target values of the alternative paths and the rank of each alternative path.

Step 3031 to step 3033 correspond to the foregoing formula (1). For either the problem that a smaller target value is preferred or a problem that a larger target value is preferred, for any multi-objective problem, a formula of an initial cost value may be obtained according to a similar concept.

In step 3034, the server determines a cost value NormCostᵢ of each alternative path according to the initial cost value of each alternative path.

An example in which a lower rank indicates a larger value of rankᵢ may be used. It can be seen from the foregoing formula of calculating the initial cost value that, a larger target value accounts for a larger proportion. That is, it indicates that a country having a lower rank or a larger target value has a larger initial cost value. However, for the problem that a smaller target value is preferred, a smaller initial cost value indicates a better alternative path and a more powerful country. To facilitate a solution of a computer, generally, a country having a larger cost value is used as the optimal solution. Therefore, for the problem that a smaller target value is preferred, an initial cost value of each country may be converted into a cost value according to the initial cost values of all the countries for subsequent processing.

Step 3034 corresponds to the foregoing formula (2). For the problem that a larger target value is preferred, the cost value of each country may be the initial cost value, or the initial cost values of all the countries may be normalized based on a same concept to obtain corresponding cost values. However, the embodiment is not is not limited thereto.

In step 304, the server determines a plurality of alternative path groups according to the cost value and the at least one target value of each alternative path.

After determining the cost value and the at least one target value of each alternative path, the server may group the plurality of alternative paths. To vividly describe a dominant relationship between different paths, each alternative path may be used as a country. Stronger countries may be used as colonial countries, and weaker countries may be used as colonies of the colonial countries. Therefore, the plurality of countries may be grouped to determine a colonial relationship between the plurality of countries.

In an embodiment, each alternative path group may include one first alternative path and one second alternative path corresponding to the first alternative path. The server may select, according to the cost value and the at least one target value of each alternative path, a plurality of better alternative paths as the first alternative paths. That is, a plurality of stronger countries are used as colonial countries. Then, remaining alternative paths may be used as the second alternative paths, and a corresponding second alternative path may be selected for each first alternative path. That is, a corresponding colony may be selected for each colonial country. Generally, the first alternative path having a larger cost value has a larger probability of obtaining the second alternative path. That is, a stronger colonial country has more colonies.

The server uses a first alternative path and a corresponding second alternative path as a group, so that the plurality of alternative path groups can be obtained. An alternative path group may serve as an empire. An empire includes a colonial country and a corresponding colony.

A specific processing process of step 304 may be as follows. The server may use an alternative path satisfying a target condition as the first alternative path according to the at least one target value of each alternative path; and select, according to a proportion value of a cost value of each first alternative path in a sum of the cost values of all the alternative paths, a second alternative path corresponding to each first alternative path from alternative paths except all first alternative paths, and uses a first alternative path and a second alternative path corresponding to the first alternative path as an alternative path group to obtain the plurality of alternative path groups.

In an embodiment, after each country is hierarchically divided according to the at least one target value of each country through the fast non-dominated sorting algorithm, first-rank countries may be determined as stronger countries among the plurality of countries. Therefore, all the first-rank countries may be used as colonial countries. Alternatively, after the cost value of each country is obtained, a preset quantity (for example, 10) of countries having the maximum cost value may be used as colonial countries. However, the preset quantity is not limited thereto, and a skilled person in the art may select a reasonable selection mode according to an actual situation.

Then, a corresponding colony may be selected for each colonial country based on, for example, a roulette wheel selection. The formula of calculating a selection probability of the colonial countries may be as follows:

$${P}_{i} = \frac{N o r {mCost}_{i}}{{\sum }_{n = 1}^{{N}_{imp}} N o r m C o s {t}_{n}} \qquad ( 3 )$$

Here, Pᵢ is a selection probability of an i^{th} colonial country, Nᵢₘₚ is a set total quantity of empires, that is, a quantity of colonial countries, NormCostᵢ is a cost value of the i^{th} country, and NormCostₙ is a cost value of an n^{th} country.

The server may select, according to the selection probability of the colonial countries, the corresponding colony of each colonial country from remaining colonial areas. Further, a colonial country and the corresponding colony may form an empire, so as to obtain a plurality of empires. Based on a concept that the colonial country and the corresponding colony generate the empire, the alternative path is divided into a first alternative path or a second alternative path. An alternative path and a corresponding second alternative path are used as an alternative path group to obtain the plurality of alternative path groups.

Step 302 to step 304 correspond to the empire initialization process in FIG. 4.

In step 305, the server optimizes each alternative path group to generate a plurality of optimized path groups.

Each alternative path group may include an optimized first alternative path and a second alternative path corresponding to the optimized first alternative path.

In this embodiment, after obtaining the initialized alternative path, the server may continuously search for a feasible solution in the solution space. When obtaining a new alternative path each time, the server may calculate the at least one target value according to the objective function, and may further determine whether the new alternative path is a better alternative path to use the better alternative path as an optimized path. When the better alternative path is found, the better alternative path may be reserved. The server determines the optimized first alternative path and the second alternative path corresponding to the optimized first alternative path to obtain the plurality of optimized path groups.

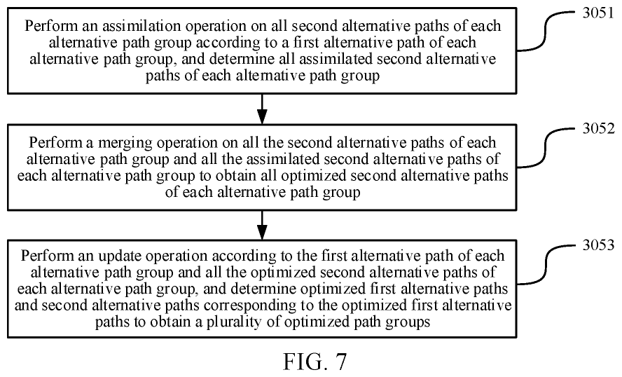

In addition, the optimization process in step 305 may include the process of an intra-empire assimilation, a population merging method and an intra-empire update in FIG. 4. Referring to a flowchart of an alternative path optimization process shown in FIG. 7, a specific processing process may include the following step 3051 to step 3053.

In step 3051, the server performs an assimilation operation on all second alternative paths of each alternative path group according to the first alternative path of each alternative path group, and determines all assimilated second alternative paths of each alternative path group.

In an empire, to enhance control of the colonies, the colonial countries assimilate their colonies to different degrees, so that the colonies are closer to that of the colonial countries (for example, weak countries need to open doors, implement a reform and opening up policy, and learn advanced technologies from strong countries to make themselves stronger). The assimilation process includes two aspects: a movement of the colony to the colonial country and an addition of a random offset after the movement. The offset is mainly to increase a diversity of the assimilation process, and expand a movement scope of the colony, so as to expand the search scope of the solution space. For the number sequence as the alternative path, the two aspects of the assimilation process may also be referred to as a crossover process and a mutation process.

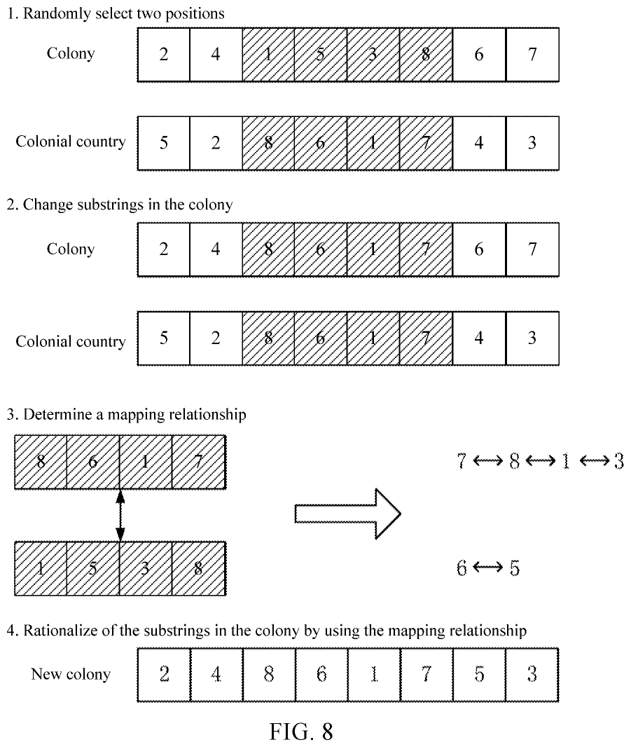

FIG. 8 is a schematic diagram of a partial cross-mapping according to an embodiment. Referring to FIG. 8, the movement in the assimilation mainly adopts a partial-mapped crossover that can reserve features of the colonial country to the colony. Specifically, a part of a crossover may be randomly selected in the number sequence of the colonial country and the colony. Then, a part of the colony that needs to be crossed may be replaced by a part of a corresponding position of the colonial country. According to a mapping relationship of the elements in the crossed part of the number sequence, other elements in the number sequence of the colony are mapped to obtain reasonable elements. Finally, a new number sequence is generated. That is, a new colony is obtained. A new alternative path is obtained by searching the solution space. The crossover may also be a crossover operator such as a single-point crossover, a multi-point crossover, and a uniform crossover, which is not limited herein.

After the partial cross-mapping, a position may be randomly selected to perform a mutation operation in the new colonial number sequence to modify sequence elements at the position. That is, the random offset is added and a new number sequence is generated. The new alternative path is obtained by searching the solution space. The offset process in the assimilation adopts four common mutation operators for random variations. The four operators may be forward and backward insertion mutations, a reverse mutation and a random two-point exchange mutation, which can effectively increase the diversity of mutations and expand the search scope.

After the operation of the crossover and the mutation, the colony is assimilated to the colonial country to obtain the assimilated colony, namely, the assimilated second alternative path. Each colony is subjected to the assimilation process to generate a corresponding assimilated colony instead of a certain probability. In this way, the search scope of the solution space can be effectively improved by preventing early falling into a local optimal solution without searching for a solution in a broader solution space.

In step 3052, the server performs a merging operation on all the second alternative paths of each alternative path group and all the assimilated second alternative paths of each alternative path group to obtain all optimized second alternative paths of each alternative path group.

In an embodiment, a stronger colony, namely, a better second alternative path, may be selected as the optimized second alternative path from all the colonies before the assimilation and all assimilated colonies. A specific processing process may include separately determining at least one target value of all the second alternative paths of each alternative path group and all the assimilated second alternative paths of each alternative path group, and determining cost values of all the second alternative paths of each alternative path group and all the assimilated second alternative paths of each alternative path group through a target combination algorithm. And then, using a preset quantity of second alternative paths having a maximum cost value in the cost values of all the second alternative paths of each alternative path group and all the assimilated second alternative paths of each alternative path group as all the optimized second alternative paths of each alternative path group.

The process of determining the cost value of the country is described above. A specific process of determining the cost value of each colony and each assimilated colony is the same as the foregoing process, and is not described herein again. Then, each colony and each assimilated colony may be ranked according to the cost value, and a quantity of colonies before the assimilation may be equal to a quantity of assimilated colonies. Therefore, a semi-colony having the maximum cost value may be used as an optimized colony, and the preset quantity is an original quantity of the colonies. In this way, a better country may be reserved to enter a next iteration. That is, a better alternative path is reserved to enter the next iteration.

In step 3053, the server performs an update operation according to the first alternative path of each alternative path group and all the optimized second alternative paths of each alternative path group, and determines optimized first alternative paths and second alternative paths corresponding to the optimized first alternative paths to obtain the plurality of optimized path groups.

If the colony in the empire is better than the colonial country to which it belongs, the colony preempts a leadership position of the colonial country, and changes the colonial country to its own colony. That is, the original colony and its corresponding colonial country exchange positions (a weak country, under control of a strong country, continues to develop and learn, and its strength exceeds the strong country, and in this case, the weak country gets rid of the control of the strong country, and controls the strong country), which is the intra-empire update. The colony preempting the leadership position serves as the optimized colonial country, and other colonies of an original colonial country correspond to a colony of the original colonial country serving as the optimized colonial country. A similar update on each empire may be performed to obtain a plurality of optimized empires. That is, the plurality of optimized path groups are obtained. Based on a concept of the intra-empire update, if the cost value of the second alternative path is greater than the cost value of the corresponding first alternative path, the second alternative path reverses a position with the first alternative path. That is, the original second alternative path is changed to a first alternative path of the alternative path group, and the original first alternative path is changed to a second alternative path of the alternative path group.

Before the intra-empire update, the optimal solution in a current empire may be compared with an optimal solution obtained from previous iterations according to a local search algorithm, and a better country is selected as a candidate country. The step corresponds to a late acceptance hill-climbing algorithm process in FIG. 4, and a specific processing process may include determining a candidate path of each alternative path group through the local search algorithm according to the first alternative path of each alternative path group and all the optimized second alternative paths of each alternative path group.

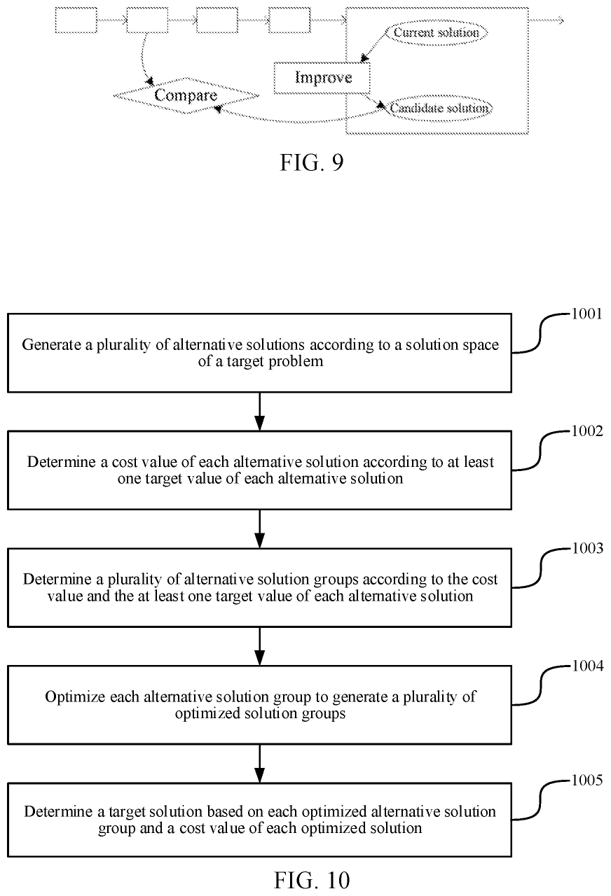

The local search algorithm may be the late acceptance hill-climbing algorithm, or may be a simulated annealing algorithm. However, it is not limited thereto. Here, the late acceptance hill-climbing algorithm is used as an example. A list of a fixed length may be set to store the optimal solution obtained from several iterations. The late acceptance hill-climbing algorithm shown in FIG. 9 compares the optimal solution in the current empire with the optimal solution obtained from the previous iterations, and selects the better country as a candidate country, namely, the candidate path. If the candidate path is a candidate path obtained from the previous iterations, the candidate path replaces the optimal solution in a current alternative path group, which is a process of improving a current solution to a candidate solution.

In a case that the candidate path is the second alternative path in a corresponding alternative path group, the candidate path is used as an optimized first alternative path of the corresponding alternative path group, the first alternative path of the corresponding alternative path group is used as an optimized second alternative path, and the optimized first alternative path and a corresponding at least one optimized second alternative path are used as an optimized path group. The alternative path group is the foregoing alternative path group. That is, the colony in the empire is better than the colonial country to which it belongs, and an intra-empire optimization operation is performed.

In a case that the candidate path is the first alternative path in a corresponding alternative path group, the first alternative path is used as an optimized first alternative path, and the optimized first alternative path and a corresponding at least one optimized second alternative path are used as an optimized path group. That is, the colonial countries in the empire still dominate their colonies, and do not perform the intra-empire update operation.

In step 306, the server determines a target running path of the robot based on each optimized path group and a cost value of each optimized alternative path.

The server may compare each optimized path group, determine a successfully competed path group among the plurality of path groups, and change a second alternative path having the lowest cost value in the path group or having the lowest energy value to a second alternative path in the successfully competed path group. However, if an algorithm stop condition is satisfied, the first alternative path satisfying the preset condition is used as the target running path of the robot.

The colonial countries in the empire are not only willing to occupy other colonial countries in the empire, but also they will choose a competitive way or a non-harmonious means to compete for other colonies in the empire (strong countries continue to expand their own forces outward to further enhance the countries' strengths, and certainly, also reduce the energy value of other empires. This is also a common occurrence that the weaker colonial countries lose their colonies). The process is colonial competition. The step may correspond to the colonial competition process in FIG. 4. The energy value of each empire may be obtained by calculating a cost value of the composition countries of the empire. The energy value may be used as an index for measuring whether one alternative path is preferred, and a specific formula may be as follows:

Powᵢ=Cost(imp)+β*mean(Cost(colonies in empire)) (4)

NormPowᵢ=max(Powₙ)−Powᵢ+1 (5)

Here, Pow, is an initial energy value of an i^{th} empire, Cost(imp) is an initial cost value of a colonial country, Cost(colonies in empire) is an initial cost value of a colony in the empire, and β is a proportionality coefficient, whose value is about 0.4. NormPowᵢ is an energy value of the i^{th} empire, and max(Powₙ) is a maximum initial energy value among all empires.

The empire having a larger energy value indicates a higher probability of successful competition. A corresponding formula may be as follows:

$${P}_{i} = \frac{N o {rmPow}_{i}}{{\sum }_{n = 1}^{{N}_{imp}} N o r m P o {w}_{n}} . \qquad ( 6 )$$

According to the formula (6), a proportion of the energy value of each empire among energy values of all the empires, that is, the probability of the successful competition of the empire, is calculated. These probability values may form a matrix P=[P₁, P₂, P₃, . . . , P_{N}_{ᵢₘₚ}]. Nᵢₘₚ numbers having a smaller value are randomly generated to form a matrix R=[r₁, r₂, r₃, . . . , r_{N}_{ᵢₘₚ}], and a matrix D=P−R=[D₁, D₂, D₃, . . . , D_{N}_{ᵢₘₚ}] may be further obtained. An empire corresponding to a maximum value in a matrix D is a successfully competed empire, and may occupy a colony having a minimum cost value in an empire having the minimum energy value. That is, the colony is changed to a successfully competed colony of the empire. If the algorithm stop condition is not satisfied in this case, step 305 and step 306 may be repeated until the algorithm stop condition is satisfied. To avoid an excessively long execution time of the algorithm, the algorithm stop condition may be preset. Specifically, the algorithm stop condition may be that only one empire remains, or a quantity of iterations reaches a preset quantity. Based on a concept of the colonial competition, a successfully competed alternative path group may obtain a second alternative path having the minimum cost value of an alternative path group having the minimum energy value.

With the continuous progress of the algorithm, an empire having a relatively low energy value may lose all its own colonies. Similarly, a new colonial country needs to be selected through the colonial competition. Otherwise, the empire disappears from a population, which is an empire elimination process in FIG. 4.

When only one empire remains, or the quantity of iterations reaches the preset quantity, the algorithm stop condition is satisfied. If only one empire remains, the colonial countries of the empire may be used as the found optimal solution. That is, the target running path of the robot of the generation problem may be obtained. If the quantity of iterations reaches the preset quantity, and more than one empire exists, a colonial country having the maximum cost value may be used as the optimal solution to obtain the target running path of the robot of the generation problem for the robot running path.

Step 306 is a process of determining, by the server, the target running path of the robot based on the plurality of alternative path groups and the cost value of each alternative path. In step 305 and step 306, the server optimizes each alternative path group, and determines the target running path of the robot based on a plurality of optimized path groups and the cost value of the optimized alternative paths. That is, the assimilation, population merging, or the update may be performed in the empire, and the energy value of the empire may be further determined based on the optimized empire.

In an embodiment, the server may also not perform step 305. That is, each alternative path group does not need to be optimized. The server directly performs the step of determining the target running path of the robot based on the plurality of alternative path groups and the cost value of each alternative path. In other words, a change between the colonies and the colonial countries in the empire may not be so rapid, and competition between the empires may be relatively fierce. Therefore, country composition of each empire may be further determined based directly on the empire determined in step 304, so as to obtain the energy value of each empire. A specific implementation used in the embodiments is not limited thereto.

In an embodiment, an improved colonial competitive algorithm is provided. For a generation problem of a multi-objective robot running path, a cost value of each alternative path may be calculated, to serve as an index for measuring whether an alternative path is preferred. Compared with an NSGA-II, the colonial competitive algorithm may distinguish each path instead of distinguishing only a Pareto solution set of a same rank. This can enhance search performance of a solution space, and expand a search scope, so that a robot running path that better satisfies a requirement can be obtained, thereby reducing running costs of a robot.

FIG. 10 is a flowchart of a method for determining a problem solution according to an embodiment. Referring to FIG. 10 and the flowchart of the multi-objective hybrid colonial competitive algorithm shown in FIG. 4, the following descriptions are provided.

In step 1001, the server generates a plurality of alternative solutions according to a solution space of a target problem.

In this embodiment, for a complex multi-objective NP-hard problem such as robot running path generation, deep learning, or test case generation, decision variables, constraints, objective functions, and the like of the target problem may be constructed, which are not limited herein. According to the constructed decision variables and constraints, a solution space of the target problem may be determined.

In the solution space of the target problem, a number sequence is randomly generated to represent a solution to the target problem. According to a preset quantity of individuals, a preset quantity of number sequences may be randomly generated. For example, 30 number sequences are generated.

In addition, a path generation problem is used as an example. The target problem of generating a path is constructed according to a path point and node description information. During construction of the target problem, the decision variables may be first constructed according to the path point, and then the constraints of the path generation problem may be constructed according to the node description information. An intermediate path point is randomly selected according to an input start path point and an input end path point to obtain an alternative path. Then, it is determined whether the alternative path satisfies the constraints. If the alternative path satisfies the constraints, it indicates that the alternative path is a feasible solution, and the alternative path may be reserved for subsequent processing. If the alternative path does not satisfy the constraints, it indicates that the alternative path is a non-feasible solution, and the alternative path may be discarded and another alternative path may be regenerated.

The decision variables of the path generation problem may include a path point, a path length, a time duration, an amount of energy consumption, and the like. The path length, the time duration, the energy consumption, and the like may be obtained by calculating the path point and a preset running speed. The node description information may be attribute information related to the path point and the constraints. For example, the node description information may be maximum traffic allowed by a node, a connection relationship between nodes (for example, passing from a node A to a node B is allowed, but passing from the node A to a node C is not allowed), or the like. The objective functions may be a single objective function. For example, the objective functions may include the shortest path, the shortest duration, the least amount of energy consumption, or the like. Alternatively, the objective functions may be a multiple objective function. For example, a combination of a path distance, the time duration, and the energy consumption that is most appropriate.

As shown in FIG. 5, which is a schematic diagram of a generation problem of a robot running path, path points may have corresponding numbers, and a number sequence may be generated according to the numbers of the path points to represent a path. The beginning of the sequence is a path start point, and the end of the sequence is a path end point. A preset quantity of number sequences are randomly generated. That is, a preset quantity of paths are randomly generated to obtain the plurality of alternative solutions.

In step 1002, the server determines a cost value of each alternative solution according to at least one target value of each alternative solution.

After the plurality of alternatives are randomly generated, to vividly describe a dominant relationship between different alternative solutions, each alternative solution may be used as a country to obtain a plurality of countries. One or more target values of each country may be calculated according to the foregoing objective function, so as to determine a cost value of each country based on the one or more target values.

In an embodiment, for a single objective problem, the target value can be directly used to represent a cost value of a country. However, for a multi-objective problem, a cost value of a country cannot be directly measured by using a certain target value, and a plurality of target values need to be combined and calculated to obtain the cost value. Cost values of the plurality of countries may be obtained through a same or similar operation on each country. Specifically, the process of determining, by the server, a cost value of each alternative solution in step 1002 may be as follows. The server determines the cost value of each alternative solution according to the at least one target value of each alternative solution by invoking a target combination algorithm.

In addition, before the cost value of each country is calculated, the server may classify each country according to a fast non-dominated sorting algorithm to obtain a rank of each country to calculate a corresponding cost value. Here, the server may obtain the rank of each country and the corresponding cost value by classifying each alternative solution according to the at least one target value of each alternative solution to obtain a rank of each alternative and determining the cost value of each alternative solution according to the at least one target value of each alternative solution and the rank of each alternative solution.

Specifically, after the at least one target value of each country is obtained, the server may determine a degree of dominance between countries according to the fast non-dominated sorting algorithm, and put each country into different levels of Pareto solution sets. Each level may correspond to a rank, and each country may obtain a corresponding rank of the country. A level of a country having a highest degree of dominance may be at a first level, and a corresponding rank may be a first rank.

Further, the server may calculate the cost value of each country through a target combination algorithm according to the at least one target value of each country and the corresponding rank. For the multi-objective problem, status equality and optimization reciprocity exist between the target values. The target combination algorithm refers to the corresponding rank of each country, and can ensure that a cost value of a country having a better Pareto solution set is also better.

The target problem being a problem including two objective functions is used as an example. If the problem is that a smaller target value is preferred, a formula of the target combination algorithm may be expressed as follows:

$$\begin{matrix}{Cost}_{i} = {\sum }_{k = 1}^{2} [ {f}_{k} ( i ) \text{/} {\sum }_{j = 1}^{{N}_{rank}} {f}_{k} ( j ) ] + {( {rank}_{i} - 1 )}^{*} 2 & ( 1 ) \\ {NormCost}_{i} = max ( C o s {t}_{n} ) - {Cost}_{i} + 1 & ( ( 2 )\end{matrix}$$

Costᵢ is an initial cost value of an i^{th} country, fₖ(i) is a k^{th} target value of the i^{th} country, fₖ(j) is a k^{th} target value of a j^{th} country, Nᵣₐₙₖ is a quantity of countries in each rank of Pareto solution set, and rankᵢ is a rank (that is, a level) corresponding to the i^{th} country. NormCostᵢ is a cost value of the i^{th} country, max(Costₙ) is a maximum value of initial cost values of all countries, and Σ is a summation function. The formula (2) shows that a country having a maximum initial cost value has a minimum cost value, and the cost value is 1. For other countries, a country whose initial cost value has a larger difference with the initial cost value of the country having the largest initial cost value has a larger corresponding cost value. Similarly, a country having a smaller initial cost value has a larger cost value, which is consistent with the problem that a smaller the target value is preferred.

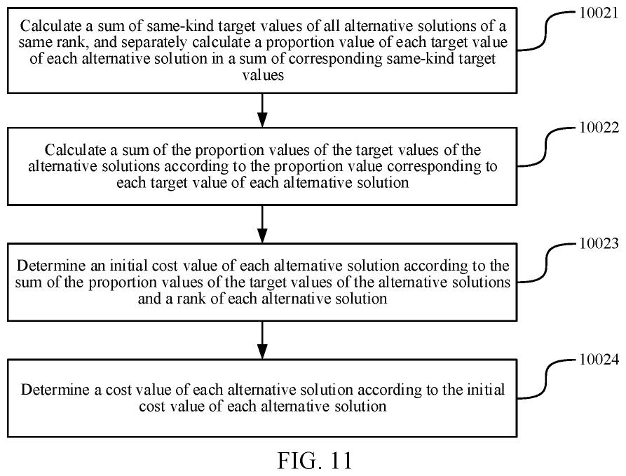

Referring to a flowchart of a target combination algorithm shown in FIG. 11, the process of calculating according to the target combination algorithm in step 1002 may be described in more detail in the following step 10021 to step 10024.

In step 10021, the server calculates a sum

$${\sum }_{{ }^{j = 1}}^{{N}_{rank}} {f}_{k} ( j )$$

of same-kind target values of all alternative solutions of a same rank, and separately calculates a proportion value

$${f}_{k} ( i ) \text{/} {\sum }_{j = 1}^{{N}_{r a n k}} {f}_{k} ( j )$$

of each target value of each alternative solution in a sum of corresponding same-kind target values.

In step 10022, the server calculates a sum

$${\sum }_{k = 1}^{2} [ {f}_{k} ( i ) \text{/} {{\sum }_{j = 1}}^{{N}_{rank}} {f}_{k} ( j ) ]$$

of the proportion values of the target values of the alternative solutions according to the proportion value corresponding to each target value of each alternative solution.

In step 10023, the server determines an initial cost value Costᵢ of each alternative solution (or path) according to the sum of the proportion values of the target values of the alternative solutions and the rank of each alternative solution.

Step 10021 to step 10023 correspond to the foregoing formula (1). For either a problem in which a smaller target value or a larger target value is preferred, or for any multi-objective problem, a formula of an initial cost value may be obtained according to a similar concept.

In step 10024, the server determines a cost value NormCostᵢ of each alternative solution according to the initial cost value of each alternative solution.

An example in which a lower rank indicates a larger value of rankᵢ is used. It can be seen from the foregoing formula of calculating the initial cost value that, a larger target value accounts for a larger proportion. That is, it indicates that a country having a lower rank or a larger target value has a larger initial cost value. However, for the problem that a smaller target value is preferred, a smaller initial cost value indicates a better alternative solution and a more powerful country. To facilitate a solution of a computer, a country having a larger cost value may be used as the optimal solution. Therefore, for the problem that a smaller target value is preferred, an initial cost value of each country may be converted into a cost value according to the initial cost values of all the countries for subsequent processing.

Step 10024 corresponds to the foregoing formula (2). For a problem in which a larger target value is preferred, the cost value of each country may be the initial cost value, or the initial cost values of all the countries may be normalized based on a same concept to obtain corresponding cost values, which is not limited herein.

In step 1003, the server determines a plurality of alternative solution groups according to the cost value and the at least one target value of each alternative solution.

After determining the cost value and the at least one target value of each alternative solution, the server may group the plurality of alternative solutions. To vividly describe a dominant relationship between different paths, each alternative solution may be used as a country. Stronger countries may be used as colonial countries, and weaker countries may be used as colonies of the colonial countries. Therefore, the plurality of countries may be grouped to determine a colonial relationship between the plurality of countries.

In an embodiment, each alternative solution group includes one first alternative solution and one second alternative solution corresponding to the first alternative solution. The server may select, according to the cost value and the at least one target value of each alternative solution, a plurality of better alternative solutions as the first alternative solutions. That is, a plurality of stronger countries are used as colonial countries. Then, remaining alternative solutions may be used as the second alternative solutions, and a corresponding second alternative solution may be selected for each first alternative solution. That is, a corresponding colony may be selected for each colonial country. Generally, a first alternative solution having a larger cost value has a larger probability of obtaining the second alternative solution. That is, a stronger colonial country has more colonies.

The server uses a first alternative solution and a corresponding second alternative solution as a group, so that the plurality of alternative solution groups can be obtained. An alternative solution group may serve as an empire. An empire includes a colonial country and a corresponding colony.

A specific processing process of step 1003 may be as follows. The server may use an alternative solution satisfying a target condition as the first alternative solution according to the at least one target value of each alternative solution. The server may select, according to a proportion value of a cost value of each first alternative solution in a sum of the cost values of all the alternative solutions, a second alternative solution corresponding to each first alternative solution from alternative solutions except all first alternative solutions, and use a first alternative solution and a second alternative solution corresponding to the first alternative solution as an alternative solution group to obtain the plurality of alternative solution groups.

In an embodiment, after each country is hierarchically arranged according to the at least one target value of each country through the fast non-dominated sorting algorithm, first-rank countries are stronger countries. Therefore, all the first-rank countries may be used as colonial countries. Alternatively, after the cost value of each country is obtained, a preset quantity (for example, 10) of countries having the maximum cost value may be used as colonial countries. A skilled person may select a reasonable selection mode according to an actual situation, which is not limited herein.

Then, a corresponding colony may be selected for each colonial country based on a roulette wheel selection. The formula of calculating a selection probability of the colonial countries may be as follows:

$${P}_{i} = \frac{N o r m C o s {t}_{i}}{{\sum }_{n = 1}^{{N}_{imp}} N o r m C o s {t}_{n}} \qquad ( 3 )$$

Pᵢ is a selection probability of an i^{th} colonial country, Nᵢₘₚ is a set total quantity of empires, that is, a quantity of colonial countries, NormCostᵢis a cost value of the i^{th} country, and NormCostₙ is a cost value of an n^{th} country.

The server selects, according to the selection probability of the colonial countries, the corresponding colony of each colonial country from remaining colonial areas. Further, a colonial country and the corresponding colony form an empire, so as to obtain a plurality of empires. Based on a concept that the colonial country and the corresponding colony form the empire, the alternative solution is divided into a first alternative solution or a second alternative solution. An alternative solution and a corresponding second alternative solution are used as an alternative solution group to obtain the plurality of alternative solution groups.

Step 1001 to step 1003 correspond to the empire initialization process in FIG. 4.

In step 1004, the server optimizes each alternative solution group to generate a plurality of optimized solution groups.

Each optimized solution group includes an optimized first alternative solution and a second alternative solution corresponding to the optimized first alternative solution.

In this embodiment, after obtaining the initialized alternative solution, the server may continuously search for a feasible solution in the solution space. When obtaining a new alternative solution each time, the server may calculate the at least one target value according to the objective function, determine whether the new alternative solution is a better alternative solution, and use the better alternative as an optimized solution. When the better alternative solution is found, the better alternative solution may be reserved. The server determines the optimized first alternative solution and the second alternative solution corresponding to the optimized first alternative solution to obtain the plurality of optimized solution groups.

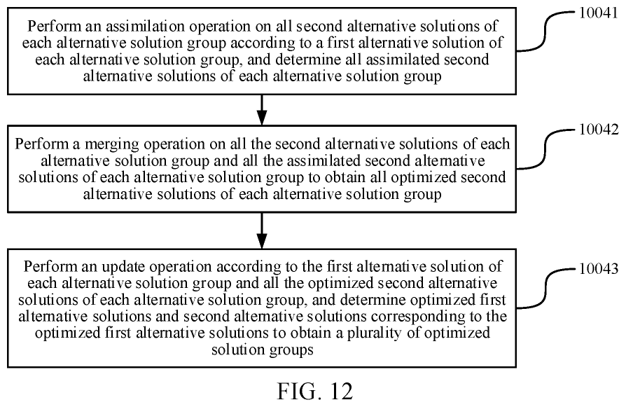

In addition, the optimization process in step 1004 may be the process of an intra-empire assimilation, a population merging method and an intra-empire update in FIG. 4. Referring to a flowchart of an alternative solution optimization process shown in FIG. 12, a specific processing process may include the following step 10041 to step 10043:

In step 10041, the server performs an assimilation operation on all second alternative solutions of each alternative solution group according to the first alternative solution of each alternative solution group, and determines all assimilated second alternative solutions of each alternative solution group.

In an empire, to enhance control of the colonies, the colonial countries assimilate their colonies to different degrees, so that the colonies are more similar to the colonial countries (for example, weak countries need to open doors, implement a reform and opening up policy, and learn advanced technologies from strong countries to make themselves stronger). The assimilation process includes two aspects: a movement of the colony to the colonial country and an addition of a random offset after the movement. The offset is mainly to increase a diversity of the assimilation process, and expand a movement scope of the colony, so as to expand the search scope of the solution space. For the number sequence as the alternative solution, the two aspects of the assimilation process may be a crossover process and a mutation process.

With respect to a first aspect, referring to a schematic diagram of a partial cross-mapping shown in FIG. 8, the movement in the assimilation mainly adopts a partial-mapped crossover that can well reserve features of the colonial country to the colony. Specifically, a part of a crossover may be randomly selected in the number sequence of the colonial country and the colony. For example, as shown in FIG. 8, a first randomly selected number sequence “24153867” represent a colony, and a second randomly selected number sequence “52861743.” Then, a part of the colony that needs to be crossed may be replaced by a part of a corresponding position of the colonial country. Here, the corresponding positions are four numbers at the center of each number sequence, for example, “1538” and “8617.” The corresponding positions (or substring) of the colony is changed to the same substring of the colonial country. For example, the substring “1538” of the colony is changed to “8617.” According to a mapping relationship of the elements in the crossed part of the number sequence, other elements in the number sequence of the colony are mapped to obtain reasonable elements. Finally, a new number sequence is generated. That is, a new colony is obtained. A new alternative solution is obtained by searching the solution space. The crossover may also be a crossover operator such as a single-point crossover, a multi-point crossover, and a uniform crossover, however it is not limited thereto.

With respect to a second aspect, after the partial cross-mapping, a position may be randomly selected to perform a mutation operation in the new colonial number sequence to modify sequence elements at the position. That is, the random offset is added. A new number sequence is generated. The new alternative solution is obtained by searching the solution space. The offset process in the assimilation adopts four common mutation operators for random variations. The four operators may be forward and backward insertion mutations, a reverse mutation and a random two-point exchange mutation, which may effectively increase the diversity of mutations and expand the search scope.

After the operation of the crossover and the mutation, the colony is assimilated to the colonial country to obtain the assimilated colony, namely, the assimilated second alternative solution. Each colony is subjected to the assimilation process to generate a corresponding assimilated colony instead of a certain probability. As such, the search scope of the solution space can be effectively improved, and may prevent falling into a local optimal solution too early.

In step 10042, the server performs a merging operation on all the second alternative solutions of each alternative solution group and all the assimilated second alternative solutions of each alternative solution group to obtain all optimized second alternative solutions of each alternative solution group.

In the embodiment, a stronger colony, namely, a better second alternative solution, may be selected as the optimized second alternative solution from all the colonies before the assimilation and all assimilated colonies. A specific processing process may include separately determining at least one target value of all the second alternative solutions of each alternative solution group and all the assimilated second alternative solutions of each alternative solution group, and determining cost values of all the second alternatives of each alternative solution group and all the assimilated second alternative solutions of each alternative solution group through a target combination algorithm. Then, the server may use a preset quantity of second alternative solutions having a maximum cost value in the cost values of all the second alternative solutions of each alternative solution group and all the assimilated second alternative solutions of each alternative solution group as all the optimized second alternative solutions of each alternative solution group.

A specific process of determining the cost value of each colony and each assimilated colony is the same as the foregoing process, and is not described herein again. Accordingly, each colony and each assimilated colony may be ranked according to the cost value, and a quantity of colonies before the assimilation is equal to a quantity of assimilated colonies. Therefore, a semi-colony having the maximum cost value may be used as an optimized colony, and the preset quantity is an original quantity of the colonies. As such, a better country may be reserved to enter a next iteration. That is, a better alternative solution is reserved to enter the next iteration.

In step 10043, the server performs an update operation according to the first alternative solution of each alternative solution group and all the optimized second alternative solutions of each alternative solution group, and determines the optimized first alternative solution and the second alternative solution corresponding to the optimized first alternative solution to obtain the plurality of optimized solution groups.

If the colony in the empire is better than the colonial country to which it belongs, the colony preempts a leadership position of the colonial country, and changes the colonial country to its own colony. That is, the original colony and its corresponding colonial country exchange positions (a weak country, under control of a strong country, continues to develop and learn, and its strength exceeds the strong country, and in this case, the weak country gets rid of the control of the strong country, and controls the strong country), which is the intra-empire update. The colony preempting the leadership position serves as the optimized colonial country, and other colonies of an original colonial country correspond to a colony of the original colonial country serving as the optimized colonial country. A similar update on each empire may be performed to obtain a plurality of optimized empires. That is, the plurality of optimized solution groups may be obtained. Based on a concept of the intra-empire update, if the cost value of the second alternative solution is greater than the cost value of the corresponding first alternative solution, the second alternative solution reverse a position with the first alternative solution. That is, the original second alternative solution is changed to a first alternative solution of the alternative solution group, and the original first alternative solution is changed to a second alternative solution of the alternative solution group.

Before the intra-empire update, the optimal solution in a current empire may be compared with an optimal solution obtained from previous iterations according to a local search algorithm, and a better country is selected as a candidate country. The step corresponds to a late acceptance hill-climbing algorithm process in FIG. 4, and a specific processing process may include determining a candidate solution of each alternative solution group through the local search algorithm according to the first alternative solution of each alternative solution group and all the optimized second alternative solutions of each alternative solution group.

The local search algorithm may be the late acceptance hill-climbing algorithm, or may be a simulated annealing algorithm, however, it is not limited thereto. Here, the late acceptance hill-climbing algorithm is used as an example. A list of a fixed length may be set to store the optimal solution obtained from several iterations. The late acceptance hill-climbing algorithm shown in FIG. 9 compares the optimal solution in the current empire with the optimal solution obtained from the previous iterations, and selects the better country as a candidate country, namely, the candidate solution. If the candidate solution is the alternative solution obtained from the previous iterations, the candidate solution replaces the optimal solution in a current alternative solution group, which is a process of improving a current solution to a candidate solution.

If the candidate solution is the second alternative solution in a corresponding alternative solution group, the candidate solution is used as an optimized first alternative solution of the corresponding alternative solution group, the first alternative solution of the corresponding alternative solution group is used as an optimized second alternative solution, and the optimized first alternative solution and a corresponding at least one optimized second alternative solution are used as an optimized solution group. The alternative solution group is the foregoing alternative solution group. That is, the colony in the empire is better than the colonial country to which it belongs, and an optimization operation in the empire is performed.

If the candidate solution is the first alternative solution in a corresponding alternative solution group, the first alternative solution is used as an optimized first alternative solution, and the optimized first alternative solution and a corresponding at least one optimized second alternative solution are used as an optimized solution group. That is, the colonial countries in the empire still dominate their colonies, and do not perform the intra-empire update operation.

In step 1005, the server determines an objective solution based on cost values of each optimized solution group and each optimized alternative solution.

The server may perform a competition operation based on each optimized solution group, determine a successfully competed solution group, and change a second alternative solution having the lowest cost value in the solution group or having the lowest energy value to a second alternative solution in the successfully competed solution group. If an algorithm stop condition is satisfied, the first alternative solution satisfying the preset condition is used as the objective solution.

The colonial countries in the empire are not only willing to occupy other colonial countries, but also they will choose a competitive way or a non-harmonious means to compete for other colonies in the empire (strong countries continue to expand their own forces outward to further enhance the national strength, and certainly, also reduce the energy value of other empires. This is also a common occurrence that the weaker colonial countries lose their colonies). The process is colonial competition. The step may correspond to the colonial competition process in FIG. 4. The energy value of each empire may be obtained by calculating a cost value of the composition countries of the empire. The energy value may be used as an index for measuring whether one alternative solution is preferred, and a specific formula may be as follows:

Powᵢ=Cost(imp)+β*mean(Cost(colonies in empire)) (4)

NormPowᵢ=max(Powₙ)−Powᵢ+1 (5)

Powᵢ is an initial energy value of an i^{th} empire, Cost(imp) is an initial cost value of a colonial country, Cost(colonies in empire) is an initial cost value of a colony in the empire, and β is a proportionality coefficient, whose value is approximately 0.4. Corresponding to the foregoing description, for the problem that a smaller value is preferred, NormPowᵢ is an energy value of the i^{th} empire, and max(Powₙ) is a maximum initial energy value among all empires.

The empire having a larger energy value has a higher probability of successful competition. A corresponding formula may be as follows:

$${P}_{i} = \frac{N o {rmPow}_{i}}{{\sum }_{n = 1}^{{N}_{imp}} N o r m P o {w}_{n}} . \qquad ( 6 )$$

According to the formula (6), a proportion of the energy value of each empire among energy values of all the empires, that is, the probability of the successful competition of the empire, is calculated. These probability values may form a matrix P=[P₁, P₂, P₃, . . . , P_{N}_{ᵢₘₚ}]. Nᵢₘₚ numbers having a smaller value are randomly generated to form a matrix R=[r₁, r₂, r₃, . . . , r_{N}_{ᵢₘₚ}], and a matrix D=P−R=[D₁, D₂, D₃, . . . , D_{N}_{ᵢₘₚ}] is further obtained. An empire corresponding to a maximum value in a matrix D is a successfully competed empire, and may occupy a colony having a minimum cost value in an empire having the minimum energy value. That is, the colony is changed to a successfully competed colony of the empire. If the algorithm stop condition is not satisfied in this case, step 1004 and step 1005 may be repeated until the algorithm stop condition is satisfied. To avoid an excessively long execution time of the algorithm, the algorithm stop condition may be set. For example, the algorithm stop condition may be that only one empire remains, or a quantity of iterations reaches a preset quantity of times. Based on a concept of the colonial competition, a successfully competed alternative solution group may obtain a second alternative solution having the minimum cost value of an alternative solution group having the minimum energy value.

With the continuous progress of the algorithm, an empire having a relatively low energy value may lose all its own colonies. In this case, the colonial countries of the empire have no meaning. Similarly, a new colonial country needs to be selected through the colonial competition. Otherwise, the empire disappears from a population, which is an empire elimination process in FIG. 4.

When only one empire remains, or the quantity of iterations reaches the preset quantity, the algorithm stop condition is satisfied. If only one empire remains, the colonial countries of the empire may be used as the found optimal solution. That is, the objective solution of the target problem is obtained. If the quantity of iterations reaches the preset quantity, and more than one empire exists, a colonial country having the maximum cost value may be used as the optimal solution to obtain the objective solution of the target problem.

Step 1005 is a process of determining, by the server, the objective solution based on the plurality of alternative solution groups and the cost value of each alternative solution. In step 1004 and step 1005, the server optimizes each alternative solution group, and determines the objective solution based on a plurality of optimized solution groups and the cost value of the optimized alternative solutions. That is, the assimilation, population merging, or the update may be performed in the empire, and the energy value of the empire may be further determined based on the optimized empire.

In an alternative embodiment, the server may not perform step 1004. That is, each alternative solution group may not be optimized. The server directly may perform the step of determining the objective solution based on the plurality of alternative solution groups and the cost value of each alternative solution. That is, a change between the colonies and the colonial countries in the empire may not be so rapid, and competition between the empires may be relatively fierce. Therefore, country composition of each empire may be further determined based directly on the empire determined in step 1003, so as to obtain the energy value of each empire. However, the specific implementation used herein is not limited thereto.

In an embodiment, an improved colonial competitive algorithm may be provided. For a multi-objective problem, a cost value of each alternative solution may be calculated, to serve as an index to measure whether an alternative solution is preferred. Compared with an NSGA-II, the colonial competitive algorithm may distinguish each solution instead of distinguishing only a Pareto solution set of a same rank, which can enhance search performance of a solution space, and expand a search scope, so that a solution that better satisfies a requirement can be obtained.

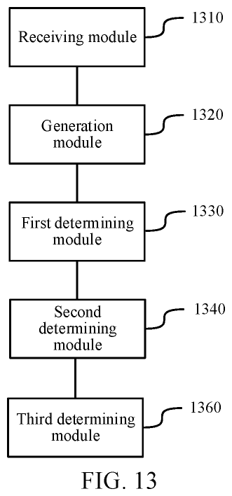

Based on the similar technical concept, embodiments further provide an apparatus for generating a robot running path. The apparatus for generating a robot running path is applied to a computing device. The computing device may be a server, or may be a terminal. FIG. 13 is a schematic diagram of an apparatus for generating a robot running path. The apparatus may include a receiving module 1310 configured to receive a path generation request, the path generation request carrying a start path point and an end path point; a generation module 1320 configured to randomly generate a plurality of alternative paths according to the start path point, the end path point, and all preset path points; a first determining module 1330 configured to determine a cost value of each alternative path according to at least one target value of each alternative path, the at least one target value including one or more of a path length of the alternative path, a time duration of the alternative path, and energy consumption of the alternative path; a second determining module 1340 configured to determine a plurality of alternative path groups according to the cost value and the at least one target value of each alternative path; and a third determining module 1360 configured to determine a target running path of a robot based on the plurality of alternative path groups and the cost value of each alternative path.

In addition, the first determining module 1330 may be configured to invoke a target combination algorithm, and determine the cost value of each alternative path according to the at least one target value of each alternative path.

The first determining module 1330 may be further configured to: classify each alternative path according to the at least one target value of each alternative path to obtain a rank of each alternative path; and determine the cost value of each alternative path according to the at least one target value of each alternative path and the rank of each alternative path.

The first determining module 1330 may be configured to: calculate a sum of same-kind target values of all alternative paths of a same rank, and separately calculate a proportion value of each target value of each alternative path in a sum of corresponding same-kind target values; calculate a sum of the proportion values of the target values of the alternative paths according to the proportion value corresponding to each target value of each alternative path; determine an initial cost value of each alternative path according to the sum of the proportion values of the target values of the alternative paths and the rank of each alternative path; and determine the cost value of each alternative path according to the initial cost value of each alternative path.

Furthermore, each alternative path group may include a first alternative path and a second alternative path corresponding to the first alternative path.

The second determining module 1340 may be further configured to: use an alternative path satisfying a target condition as the first alternative path according to the at least one target value of each alternative path; and select, according to a proportion value of a cost value of each first alternative path in a sum of the cost values of all the alternative paths, a second alternative path corresponding to each first alternative path from alternative paths except all first alternative paths, and use a first alternative path and a second alternative path corresponding to the first alternative path as an alternative path group to obtain the plurality of alternative path groups.

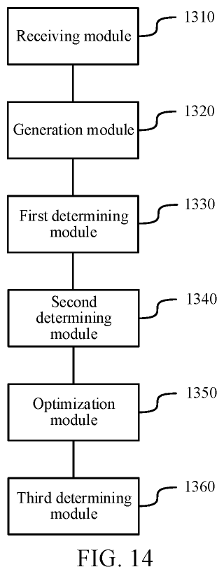

In addition, as shown in FIG. 14, the apparatus further includes an optimization module 1350. The optimization module 1350 is configured to optimize each alternative path group to generate a plurality of optimized path groups, each optimized path group including an optimized first alternative path and a second alternative path corresponding to the optimized first alternative path.

Correspondingly, the third determining module 1360 is configured to determine the target running path of the robot based on each optimized path group and a cost value of each optimized alternative path.

The optimization module 1350 may be further configured to: perform an assimilation operation on all second alternative paths of each alternative path group according to the first alternative path of each alternative path group, and determine all assimilated second alternative paths of each alternative path group; perform a merging operation on all the second alternative paths of each alternative path group and all the assimilated second alternative paths of each alternative path group to obtain all optimized second alternative paths of each alternative path group; and perform an update operation according to the first alternative path of each alternative path group and all the optimized second alternative paths of each alternative path group, and determine the optimized first alternative path and the second alternative path corresponding to the optimized first alternative path to obtain the plurality of optimized path groups.

The optimization module 1350 may be further configured to: separately determine at least one target value of all the second alternative paths of each alternative path group and all the assimilated second alternative paths of each alternative path group, and determine cost values of all the second alternative paths of each alternative path group and all the assimilated second alternative paths of each alternative path group through a target combination algorithm; and use a preset quantity of second alternative paths having a maximum cost value in the cost values of all the second alternative paths of each alternative path group and all the assimilated second alternative paths of each alternative path group as all the optimized second alternative paths of each alternative path group.

The optimization module 1350 may be configured to: determine a candidate path of each alternative path group through a local search algorithm according to the first alternative path of each alternative path group and all the optimized second alternative paths of each alternative path group; in a case that the candidate path is the second alternative path in a corresponding alternative path group, use the candidate path as an optimized first alternative path of the corresponding alternative path group, use the first alternative path of the corresponding alternative path group as an optimized second alternative path, and use the optimized first alternative path and a corresponding at least one optimized second alternative path as an optimized path group; and in a case that the candidate path is the first alternative path in a corresponding alternative path group, use the first candidate path as an optimized first alternative path, and use the optimized first alternative path and a corresponding at least one optimized second alternative path as an optimized path group.

In an embodiment, an improved colonial competitive algorithm may be provided. For a generation problem of a multi-objective robot running path, a cost value of each alternative path may be calculated, to serve as an index for measuring whether an alternative path is preferred. Compared with an NSGA-II, the colonial competitive algorithm may distinguish each path instead of distinguishing only a Pareto solution set of a same rank, which can enhance search performance of a solution space, and expand a search scope, so that a robot running path that better satisfies a requirement can be obtained, thereby reducing running costs of a robot.

The apparatus for generating a robot running path provided in the foregoing embodiments generates the robot running path. However, the division of the foregoing function modules is used as an example for illustration. During actual application, the foregoing functions may be distributed to different function modules and be implemented according to requirements, that is, an inner structure of the computing device may be divided into different function modules to implement all or some of the functions described above.

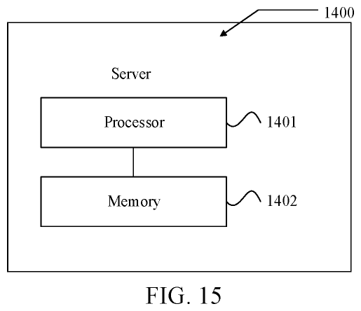

FIG. 15 is a schematic structural diagram of a computing device according to an embodiment. The computing device may be provided as a server, or may be provided as a terminal, which is not limited in this embodiment of this application. The computing device 1400 may vary based on different configurations or performance, and may include one or more processors (central processing unit, CPU) 1401 and one or more memories 1402. The memory 1402 stores at least one instruction, the at least one instruction being loaded and executed by the processor 1401 to implement the following method steps of the method for generating a robot running path: receiving a path generation request, the path generation request carrying a start path point and an end path point; randomly generating a plurality of alternative paths according to the start path point, the end path point, and all preset path points, each alternative path including one or more of the following target values: a path length of the alternative path, duration consumption of the alternative path, and energy consumption of the alternative path; determining a cost value of each alternative path according to at least one target value of each alternative path, the at least one target value including one or more of the following: a path length of the alternative path, duration consumption of the alternative path, and energy consumption of the alternative path; determining a plurality of alternative path groups according to the cost value and the at least one target value of each alternative path; and determining a target running path of a robot based on the plurality of alternative path groups and the cost value of each alternative path.

In addition, the at least one instruction may be loaded and executed by the processor 1401 to determine the cost value of each alternative path according to the at least one target value of each alternative path by invoking a target combination algorithm.

The at least one instruction may be loaded and executed by the processor 1401 to implement the following method steps: classifying each alternative path according to the at least one target value of each alternative path to obtain a rank of each alternative path; and determining the cost value of each alternative path according to the at least one target value of each alternative path and the rank of each alternative path.

The at least one instruction may be loaded and executed by the processor 1401 to implement the following method steps: calculating a sum of same-kind target values of all alternative paths of a same rank, and separately calculating a proportion value of each target value of each alternative path in a sum of corresponding same-kind target values; calculating a sum of the proportion values of the target values of the alternative paths according to the proportion value corresponding to each target value of each alternative path; determining an initial cost value of each alternative path according to the sum of the proportion values of the target values of the alternative paths and the rank of each alternative path; and determining the cost value of each alternative path according to the initial cost value of each alternative path.

Each alternative path group includes one first alternative path and a second alternative path corresponding to the first alternative path.

The at least one instruction may be loaded and executed by the processor 1401 to implement the following method steps: using an alternative path satisfying a target condition as the first alternative path according to the at least one target value of each alternative path; and selecting, according to a proportion value of a cost value of each first alternative path in a sum of the cost values of all the alternative paths, a second alternative path corresponding to each first alternative path from alternative paths except all first alternative paths, and using a first alternative path and a second alternative path corresponding to the first alternative path as an alternative path group to obtain the plurality of alternative path groups.

The at least one instruction may be loaded and executed by the processor 1401 to optimize each alternative path group to generate a plurality of optimized path groups, each optimized path group including an optimized first alternative path and a second alternative path corresponding to the optimized first alternative path.

Correspondingly, the at least one instruction may be loaded and executed by the processor 1401 to determine the target running path of the robot based on each optimized path group and a cost value of each optimized alternative path.

Furthermore, the at least one instruction may be loaded and executed by the processor 1401 to implement the following method steps: performing an assimilation operation on all second alternative paths of each alternative path group according to the first alternative path of each alternative path group, and determining all assimilated second alternative paths of each alternative path group; performing a merging operation on all the second alternative paths of each alternative path group and all the assimilated second alternative paths of each alternative path group to obtain all optimized second alternative paths of each alternative path group; and performing an update operation according to the first alternative path of each alternative path group and all the optimized second alternative paths of each alternative path group, and determining the optimized first alternative path and the second alternative path corresponding to the optimized first alternative path to obtain the plurality of optimized path groups.

The at least one instruction may be loaded and executed by the processor 1401 to implement the following method steps: separately determining at least one target value of all the second alternative paths of each alternative path group and all the assimilated second alternative paths of each alternative path group, and determining cost values of all the second alternative paths of each alternative path group and all the assimilated second alternative paths of each alternative path group through a target combination algorithm; and using a preset quantity of second alternative paths having a maximum cost value in the cost values of all the second alternative paths of each alternative path group and all the assimilated second alternative paths of each alternative path group as all the optimized second alternative paths of each alternative path group.

The at least one instruction may be loaded and executed by the processor 1401 to implement the following method steps: determining a candidate path of each alternative path group through a local search algorithm according to the first alternative path of each alternative path group and all the optimized second alternative paths of each alternative path group; and in a case that the candidate path is a second alternative path in the corresponding alternative path group, using the candidate path as an optimized first alternative path of the corresponding alternative path group, using the first alternative path of the corresponding alternative path group as an optimized second alternative path, and using the optimized first alternative path and at least one corresponding optimized second alternative path as an optimized path group; or in a case that the candidate path is a first alternative path in the corresponding alternative path group, using the first candidate path as an optimized first alternative path, and using the optimized first alternative path and at least one corresponding optimized second alternative path as an optimized path group.

In an embodiment, an improved colonial competitive algorithm is provided. For a generation problem of a multi-objective robot running path, a cost value of each alternative path may be calculated, to serve as an index for measuring whether an alternative path is preferred. Compared with an NSGA-II, the colonial competitive algorithm may distinguish each path instead of distinguishing only a Pareto solution set of a same rank, which can enhance search performance of a solution space, and expand a search scope, so that a robot running path that better satisfies a requirement can be obtained, thereby reducing running costs of a robot.

In an embodiment, a computer-readable storage medium, for example, a memory including instructions, is further provided. The instructions may be executed by a processor in a computing device, to complete the method for generating a robot running path or the method for determining a problem solution in the foregoing embodiments. For example, the computer-readable storage medium may be a read-only memory (ROM), a random access memory (RAM), a compact disc read-only memory (CD-ROM), a magnetic tape, a floppy disk, an optical data storage device, or the like.

A person of ordinary skill in the art may understand that all or some of the steps of the embodiments may be implemented by hardware or a program instructing related hardware. The program may be stored in a computer-readable storage medium. The storage medium may be a read-only memory, a magnetic disk, an optical disc, or the like.

The foregoing descriptions are merely example embodiments of the disclosure, and are not intended to limit the scope of the embodiments of the disclosure. Any modification, equivalent replacement, improvement, and the like made within the spirit and principle of the disclosure shall fall within the protection scope of the disclosure.

What is claimed is:

1. A method for generating a robot running path, performed by a computing device, the method comprising:
receiving a path generation request, the path generation request including a start path point and an end path point;
randomly generating a plurality of alternative paths according to the start path point, the end path point, and preset path points;
determining a cost value of each alternative path in the plurality of alternative paths according to at least one target value of each alternative path, the at least one target value comprising at least one of a path length, a time duration, or an amount of energy consumption of the alternative path;
determining a plurality of alternative path groups according to the cost value and the at least one target value of each alternative path; and
determining a target running path of a robot based on the plurality of alternative path groups and the cost value of each alternative path.

2. The method according to claim 1, wherein the determining the cost value of each alternative path further comprises determining the cost value of each alternative path according to the at least one target value of each alternative path based on a target combination algorithm.

3. The method according to claim 2, wherein the determining the cost value of each alternative path according to the at least one target value of each alternative path based on the target combination algorithm comprises:
classifying each alternative path according to the at least one target value of each alternative path to obtain a rank of each alternative path among the plurality of alternative paths; and
determining the cost value of each alternative path according to the at least one target value of each alternative path and the rank of each alternative path.

4. The method according to claim 3, wherein the determining the cost value of each alternative path according to the at least one target value of each alternative path and the rank of each alternative path comprises:
calculating a sum of first target values of a first group of the plurality of alternative paths having a first rank, and separately calculating a proportion value of each first target value in the sum of the first target values;
calculating a sum of the proportion values of the first target values of the alternative paths according to the proportion value corresponding to each first target value of each alternative path in the first group;
determining an initial cost value of each alternative path according to the sum of the proportion values and the first rank; and
determining the cost value of each alternative path according to the initial cost value of each alternative path.

5. The method according to claim 1, wherein each alternative path group among the plurality of alternative path groups comprises a first alternative path and a second alternative path corresponding to the first alternative path; and
wherein the determining the plurality of alternative path groups according to the cost value and the at least one target value of each alternative path further comprises:
using an alternative path satisfying a target condition as the first alternative path according to the at least one target value of each alternative path; and
selecting, according to a proportion value of the cost value of the first alternative path in a sum of the cost values of the plurality of alternative paths, the second alternative path corresponding to the first alternative path, and using the first alternative path and the second alternative path corresponding to the first alternative path as the alternative path group to obtain the plurality of alternative path groups.

6. The method according to claim 1, wherein after the determining the plurality of alternative path groups according to the cost value and the at least one target value of each alternative path, the method further comprises:
optimizing each alternative path group among the plurality of alternative path groups to generate a plurality of optimized path groups, each optimized path group comprising an optimized first alternative path and a second alternative path corresponding to the optimized first alternative path, and
wherein the determining the target running path of the robot based on the plurality of alternative path groups and the cost value of each alternative path further comprises determining the target running path of the robot based on each optimized path group and a cost value of each optimized alternative path.

7. The method according to claim 6, wherein the optimizing each alternative path group to generate a plurality of optimized path groups comprises:
performing an assimilation operation on all second alternative paths of each alternative path group according to the first alternative path of each alternative path group;
performing a merging operation on all the second alternative paths of each alternative path group and all the assimilated second alternative paths of each alternative path group to obtain all optimized second alternative paths of each alternative path group; and
performing an update operation according to the first alternative path of each alternative path group and all the optimized second alternative paths of each alternative path group, and determining the optimized first alternative path and the second alternative path corresponding to the optimized first alternative path to obtain the plurality of optimized path groups.

8. The method according to claim 7, wherein the performing the merging operation on all the second alternative paths of each alternative path group and all the assimilated second alternative paths of each alternative path group to obtain all optimized second alternative paths of each alternative path group further comprises:
separately determining at least one target value of all the second alternative paths of each alternative path group and all the assimilated second alternative paths of each alternative path group, and determining cost values of all the second alternative paths in each alternative path group and all the assimilated second alternative paths in each alternative path group based on a target combination algorithm; and
using a preset quantity of the second alternative paths having a maximum cost value in the cost values of all the second alternative paths of each alternative path group and all the assimilated second alternative paths of each alternative path group as all the optimized second alternative paths of each alternative path group.

9. The method according to claim 7, wherein the performing the update operation according to the first alternative path of each alternative path group and all the optimized second alternative paths of each alternative path group, and determining the optimized first alternative path and the second alternative path corresponding to the optimized first alternative path to obtain the plurality of optimized path groups further comprises:
determining a candidate path of each alternative path group according to a local search algorithm based on the first alternative path of each alternative path group and all the optimized second alternative paths of each alternative path group; and
based on determining that the candidate path is the second alternative path in the corresponding alternative path group, using the candidate path as an optimized first alternative path of the corresponding alternative path group, using the first alternative path of the corresponding alternative path group as an optimized second alternative path, and using the optimized first alternative path and at least one corresponding optimized second alternative path as an optimized path group; or
based on determining that the candidate path is the first alternative path in the corresponding alternative path group, using the first alternative path as an optimized first alternative path, and using the optimized first alternative path and at least one corresponding optimized second alternative path as the optimized path group.

10. A computing device, comprising:
at least one memory configured to store computer program code; and
at least one processor configured to access the computer program code and operate as instructed by the computer program code, the computer program code comprising:
receiving code configured to cause the at least one processor to receive a path generation request, the path generation request including a start path point and an end path point;
generation code configured to cause the at least one processor to randomly generate a plurality of alternative paths according to the start path point, the end path point, and preset path points;
first determining code configured to cause the at least one processor to determine a cost value of each alternative path in the plurality of alternative paths according to at least one target value of each alternative path, the at least one target value comprising at least one of a path length, a time duration, and an amount of energy consumption of the alternative path;
second determining code configured to cause the at least one processor to determine a plurality of alternative path groups according to the cost value and the at least one target value of each alternative path; and
third determining code configured to cause the at least one processor to determine a target running path of a robot based on the plurality of alternative path groups and the cost value of each alternative path.

11. The computing device according to claim 10, wherein the first determining code is further configured to cause the at least one processor to determine the cost value of each alternative path according to the at least one target value of each alternative path based on a target combination algorithm.

12. The computing device according to claim 11, wherein the first determining code is further configured to cause the at least one processor to:
classify each alternative path according to the at least one target value of each alternative path to obtain a rank of each alternative path among the plurality of alternative paths; and
determine the cost value of each alternative path according to the at least one target value of each alternative path and the rank of each alternative path.

13. The computing device according to claim 12, wherein the first determining code is further configured to cause the at least one processor to:
calculate a sum of first target values of a first group of the plurality of alternative paths having a first rank, and separately calculating a proportion value of each first target value in the sum of the first target values;
calculate a sum of the proportion values of the first target values of the alternative paths according to the proportion value corresponding to each first target value of each alternative path in the first group;
determine an initial cost value of each alternative path according to the sum of the proportion values and the first rank; and
determine the cost value of each alternative path according to the initial cost value of each alternative path.

14. The computing device according to claim 10, wherein each alternative path group among the plurality of alternative path groups comprises a first alternative path and a second alternative path corresponding to the first alternative path, and
wherein the second determining code is further configured to cause the at least one processor to:
use an alternative path satisfying a target condition as the first alternative path according to the at least one target value of each alternative path; and
select, according to a proportion value of the cost value of the first alternative path in a sum of the cost values of the plurality of alternative paths, the second alternative path corresponding to the first alternative path, and using the first alternative path and the second alternative path corresponding to the first alternative path as the alternative path group to obtain the plurality of alternative path groups.

15. The computing device according to claim 10, wherein the second determining code is further configured to cause the at least one processor to optimize each alternative path group among the plurality of alternative path groups to generate a plurality of optimized path groups, each optimized path group comprising an optimized first alternative path and a second alternative path corresponding to the optimized first alternative path, and
wherein the third determining code is further configured to cause the at least one processor to determine the target running path of the robot based on each optimized path group and a cost value of each optimized alternative path.

16. The computing device according to claim 15, further comprising:
an optimization code configured to cause the at least one processor to:
perform an assimilation operation on all second alternative paths of each alternative path group according to the first alternative path of each alternative path group;
perform a merging operation on all the second alternative paths of each alternative path group and all the assimilated second alternative paths of each alternative path group to obtain all optimized second alternative paths of each alternative path group; and
perform an update operation according to the first alternative path of each alternative path group and all the optimized second alternative paths of each alternative path group, and determining the optimized first alternative path and the second alternative path corresponding to the optimized first alternative path to obtain the plurality of optimized path groups.

17. The computing device according to claim 16, wherein the optimization code is further configured to cause the at least one processor to:
separately determine at least one target value of all the second alternative paths of each alternative path group and all the assimilated second alternative paths of each alternative path group, and determining cost values of all the second alternative paths in each alternative path group and all the assimilated second alternative paths in each alternative path group based on a target combination algorithm; and
using a preset quantity of the second alternative paths having a maximum cost value in the cost values of all the second alternative paths of each alternative path group and all the assimilated second alternative paths of each alternative path group as all the optimized second alternative paths of each alternative path group.

18. The computing device according to claim 16, wherein the optimization code is further configured to cause the at least one processor to:
determine a candidate path of each alternative path group according to a local search algorithm based on the first alternative path of each alternative path group and all the optimized second alternative paths of each alternative path group; and
based on determining that the candidate path is the second alternative path in the corresponding alternative path group, using the candidate path as an optimized first alternative path of the corresponding alternative path group, using the first alternative path of the corresponding alternative path group as an optimized second alternative path, and using the optimized first alternative path and at least one corresponding optimized second alternative path as an optimized path group; or based on determining that the candidate path is the first alternative path in the corresponding alternative path group, using the first candidate path as an optimized first alternative path, and using the optimized first alternative path and at least one corresponding optimized second alternative path as the optimized path group.

19. A non-transitory computer-readable storage medium, storing one or more programs including at least one instruction, when the at least one instruction is loaded and executed by a processor, cause the processor to:
receive a path generation request, the path generation request including a start path point and an end path point;
randomly generate a plurality of alternative paths according to the start path point, the end path point, and preset path points;
determine a cost value of each alternative path in the plurality of alternative paths according to at least one target value of each alternative path, the at least one target value comprising at least one of a path length, a time duration, and an amount of energy consumption of the alternative path;
determine a plurality of alternative path groups according to the cost value and the at least one target value of each alternative path; and
determine a target running path of a robot based on the plurality of alternative path groups and the cost value of each alternative path.

20. The non-transitory computer-readable storage medium according to claim 19, wherein the at least one instruction is loaded and executed by the processor to:
optimize each alternative path group among the plurality of alternative path groups to generate a plurality of optimized path groups, each optimized path group comprising an optimized first alternative path and a second alternative path corresponding to the optimized first alternative path; and
determine the target running path of the robot based on each optimized path group and a cost value of each optimized alternative path.
